(19) United States
(12) Patent Application Publication
(10) Pub. No.: US 2022/0285961 A1
(43) Pub. Date: Sep. 8, 2022

(54) COOPERATIVE ORCHESTRATION AND SCHEDULING OF RECHARGEABLE ENERGY-POWERED DEVICES

(71) Applicant: Solana Technologies, Inc., Vista, CA (US)

(72) Inventors: Kenneth Stanwood, Vista, CA (US); David Gell, San Diego, CA (US)

(73) Assignee: Solana Technologies, Inc., Vista, CA (US)

(21) Appl. No.: 17/652,567

(22) Filed: Feb. 25, 2022

Related U.S. Application Data
(60) Provisional application No. 63/155,470, filed on Mar. 2, 2021.

(51) Int. Cl. H02J 7/00

(52) U.S. Cl. CPC H02J 7/0071; H02J 7/0013; H02J 7/0048; H02J 7/00034; H02J 7/0068

(57) ABSTRACT

A resource orchestration system includes a plurality of rechargeable devices each comprising a rechargeable power storage unit, a resource manager, and a service unit, wherein the resource manager prepares a device report for the rechargeable device that is related to a service period, a resource orchestrator that is in communication with the plurality of rechargeable devices, that receives the device report, that generates a future service map that includes at least one customer item assignment for a future service period, and that sends the future service map to the resource manager of each of the plurality of rechargeable devices, wherein the resource manager of the at least one of the plurality of rechargeable devices directs the associated service unit to provide a service to an associated customer item during the future service period in accordance with the at least one customer item assignment provided in the future service map.

### FIELD OF THE INVENTION

This application relates to the orchestration and scheduling of intelligent, rechargeable-energy powered devices containing a power storage source such a battery or capacitor which may be recharged by power limited systems such as solar or wind generation or physically distant recharge stations which may require time and energy to reach. These can include satellite communications systems, multi-payload satellite systems, and battery supported rechargeable energy powered Internet of Things (IoT) devices.

### BACKGROUND

Low Earth Orbit (LEO) satellites commonly are powered by solar energy in combination with power storage in batteries or capacitors. For ease of explanation, the term “power storage” will be used to denote power storage in one or more batteries, one or more capacitors, or any combination of components capable of storing electrical power. The power storage capacity must be sufficient to power the satellite's electrical demands while in the Earth's shadow, thereby supporting operation in the portion of the Earth that is experiencing nighttime. The solar system and power storage charging system on the satellite must be sufficient to simultaneously power the satellite's electrical demands and recharge the power storage.

IoT devices may be powered by intermittent sources of energy such as renewable energy, in combination with power storage in a batteries or capacitors. The power storage capacity must be sufficient to power the IoT device's electrical demands during periods of insufficient renewable energy production, such as during the nighttime. The renewable energy system and power storage charging system on the IoT device must be sufficient to simultaneously power the IoT device's electrical demands and recharge the power storage. Additionally, or alternatively, power storage may be recharged by a power source located at a remote recharging station as with the example of battery powered, terrestrial robots.

LEO communication satellite systems are often dedicated to the function of providing communications services to terrestrial users. In addition, as shown in FIG. 1, geographical coverage may become congested over certain portions of the Earth. With limited spectrum resources this may necessitate a portion of the satellites to refrain from operating in order to minimize interference with neighboring satellites. Such modifications to a satellite's operation may impact power consumption. Further, the presence or lack of customers in a geographic area may impact a satellite's power consumption.

Similarly, IoT device functions may include sensing, vision systems, or other functions which interact with the physical environment. When multiple IoT devices are deployed, these device functions may provide overlapping coverage.

For the purposes of clarity, the term “device” is used herein to describe any rechargeable power storage supported system which provides one or more value-creating services to a customer. Examples of devices may include the following: (1) a satellite or a satellite hosted payload providing internet connectivity, environmental sensing, mapping or photogrammetry services, image capture over a static or dynamic region of the Earth, or other functionality; and (2) an IoT device, module, equipment, or apparatus which provides sensing of and/or interactions with a local environment, or other functionality. For example, an IoT device may be a warehouse robot picking up and placing objects on a shelf, an autonomous vehicle picking up and delivering people or cargo, a drone providing mapping or photogrammetry services, or a robotic vacuum. A device may operate on land, at sea, in the air, underwater or in space.

In many cases, more than one device (a “fleet”) may provide services in an overlapping region, area or set of customers. For example, two satellites may be able to provide Internet connectivity to the same subset of customers at the same time. Similarly, multiple warehouse robots may have access to the same shelves and bins, and many autonomous vehicles may be able to retrieve and deliver packages or persons to the same addresses.

A “customer” may be a person or machine receiving a service. For example, a customer may be the smartphone of a person paying for connectivity service, or a sea-surface sensor which needs to transmit updated sea temperature readings to a central server. A customer may also be defined as an area or geography of service. For example, each 10 m×10 m area of a warehouse may be considered a customer for a fleet of floor-cleaning robots. Similarly, a 1 km×1 km area of land may be considered a customer for a fleet of image capturing satellites.

In view of the foregoing, it should be appreciated that the management of devices within a fleet of devices in order to provide associated service(s) to customers in an operational environment may be difficult and problematic in view of the power requirements and/or constraints of each device in the fleet.

### SUMMARY OF THE INVENTION

In an aspect, a resource orchestration system is provided for the orchestration and scheduling of rechargeable devices, the resource orchestration system comprising a plurality of rechargeable devices, each rechargeable device comprising a rechargeable power storage unit, a resource manager, and a service unit that provides a service to a customer item, wherein the resource manager prepares a device report for the rechargeable device that is related to a service period, a resource orchestrator that is in communication with the plurality of rechargeable devices, that receives the device report from the resource manager of each rechargeable device, that generates a future service map that includes at least one customer item assignment of a customer item to one of the plurality of rechargeable devices for a future service period, and that sends the future service map to the resource manager of each of the plurality of rechargeable devices, wherein the resource manager of the at least one of the plurality of rechargeable devices directs the associated service unit to provide a service to an associated customer item during the future service period in accordance with the at least one customer item assignment provided in the future service map.

In another aspect, a rechargeable device is provided that comprises a rechargeable power storage unit, a resource manager that prepares a device report for the rechargeable device related to a service period, sends the device report to a resource orchestrator, and receives a future service map from the resource orchestrator, and a service unit for providing at least one service to at least one customer item, wherein the resource manager directs the service unit to provide a service to at least one customer item during the future service period in accordance with at least one customer item assignment provided in the future service map.

In a further aspect, a method is provided for the orchestration and scheduling of rechargeable devices, the method comprising the steps of receiving, from a resource manager provided in each of a plurality of rechargeable devices, a device report for the associated rechargeable device related to a service period, generating a future service map that includes at least one customer item assignment of a customer item to one of the plurality of rechargeable devices for a future service period, and sending the future service map to the resource manager of each of the plurality of rechargeable devices.

In yet another aspect, a resource orchestrator is provided for the orchestrating and scheduling of a plurality of rechargeable devices, the resource orchestrator comprising a transceiver that is capable of communication with each of the plurality of rechargeable devices, a memory that stores data and executable program instructions, the memory being coupled to the transceiver, and a processor that is coupled to the transceiver and to the memory, the processor being configured to execute the executable program instructions to perform the steps of receiving, from a resource manager provided in each of a plurality of rechargeable devices, a device report for the associated rechargeable device related to a service period, generating a future service map that includes at least one customer item assignment of a customer item to one of the plurality of rechargeable devices for a future service period, and sending the future service map to the resource manager of each of the plurality of rechargeable devices.

The foregoing aspects, and other features and advantages of the invention, will be apparent from the following, more particular description of aspects of the invention, the accompanying drawings, and the claims.

### BRIEF DESCRIPTION OF THE DRAWINGS

Details of one or more implementations of the subject matter of the invention are set forth in the accompanying drawings briefly described below and the related description set forth herein. Other objects, features, aspects, and advantages will become apparent from the description, the drawings, and the claims. Note that the relative dimensions of the drawings may not be drawn to scale. Like reference numbers and designations in the various drawings indicate like elements.

FIG. 1 is a top-level diagram of a satellite constellation for providing internet connectivity according to aspects of the invention;

FIG. 2 is a functional block diagram of a satellite system comprised of two satellites that communicate with a resource orchestrator according to aspects of the invention;

FIG. 3a is a top-level diagram of a satellite system in which two ground stations have an overlapping coverage area according to aspects of the invention;

FIG. 3b is a top-level diagram of a warehouse robot system in which robots have an overlapping coverage area according to aspects of the invention;

FIG. 4 is a flowchart depicting a method for orchestrating and scheduling device service based on device energy resources according to aspects of the invention;

FIG. 5 is a flowchart depicting a method for determining a future device service map according to aspects of the invention;

FIG. 6 is a functional block diagram of an Internet-of-Things (IoT) system comprised of two IoT devices that communicate with a resource orchestrator according to aspects of the invention;

FIG. 7 is a ladder diagram depicting a message flow between a resource orchestrator and a resource manager according to aspects of the invention;

FIG. 8 is a diagram depicting an energy report according to aspects of the invention;

FIG. 9 is a diagram depicting a local service report according to aspects of the invention; and

FIG. 10 is a diagram depicting a future service map according to aspects of the invention.

### DETAILED DESCRIPTION

Aspects of the present invention and their advantages may be understood by referring to the figures and the following description. The descriptions and features disclosed herein can be applied to various devices, systems, software, and methods related to power management and power recharging.

Aspects of the invention relate to the orchestration and scheduling of rechargeable-energy powered devices. For example, when satellites have overlapping coverage areas, power consumption may advantageously be managed within each satellite and also may be collaboratively orchestrated and scheduled among the satellites to optimize service quality, power consumption, power storage capacity, and battery life. Similarly, when IoT devices have overlapping coverage areas, power consumption may be advantageously managed within each device and also may be collaboratively orchestrated and scheduled among the devices to optimize service quality, power consumption, power storage capacity, and battery life.

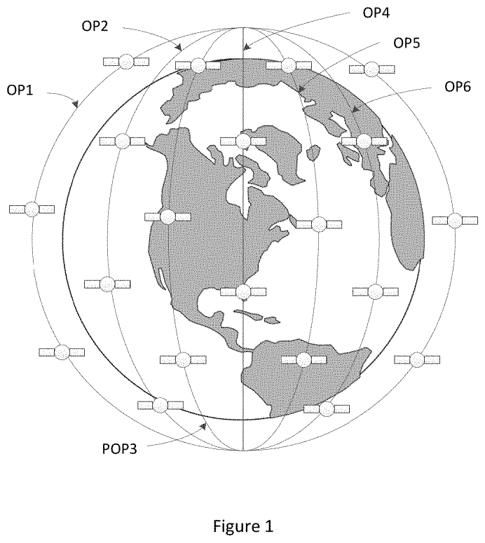

FIG. 1 shows a picture of the earth with an exemplary satellite constellation intended to provide internet connectivity services comprising six separate orbital paths, labeled OP1 through OP6, according to an aspect. More than one satellite may follow the same orbital path, as shown in FIG. 1. The orbital paths shown are for example only. Other orbital inclinations and orbital paths are known in the art. Six orbital paths are shown for example only. Other numbers of orbital paths are known in existing and planned satellite constellations. This exemplary constellation is useful for describing scenarios that may arise in satellite communications.

Note that some satellites are positioned above very large bodies of water such as the Pacific Ocean where it may be impractical to place ground stations. Other satellites may be positioned over large countries with whom the satellite system operator does not have an agreement to place ground stations or to transmit at certain frequencies. These countries may prohibit certain satellite transmissions while the satellites are passing over their lands. This situation is addressed by having the satellite not transmit while transiting these countries, which can cause coverage gaps in the timeline of visibility of a particular satellite. Therefore, there may be times when it is technically possible for the satellite to communicate with a mobile station or a ground station, but the satellite does not communicate due to an intentional outage of coverage. In other cases, there may be no suitable place for a ground station or there may be no customers requiring satellite services.

As seen in FIG. 1, there may be substantial overlap of the orbital paths OP1 through OP6, for instance at the poles of the set of orbital paths which, due to inclination of the orbits, may or may not coincide with the Earth's poles. This may cause the coverage areas on two or more satellites to substantially overlap simultaneously. Too many satellites operating in the same space at the same time and on the same frequencies can cause interference. This is aggravated by constellations with more satellites and more overlap at the poles of the orbits. It can be alleviated by having some satellites temporarily turn off some or all channels on some or all of their spot beams or other transmission modules.

The times when a satellite is not in the Earth's shadow and also when a satellite is intentionally not transmitting may allow for maximum recharging of power storage on the satellite.

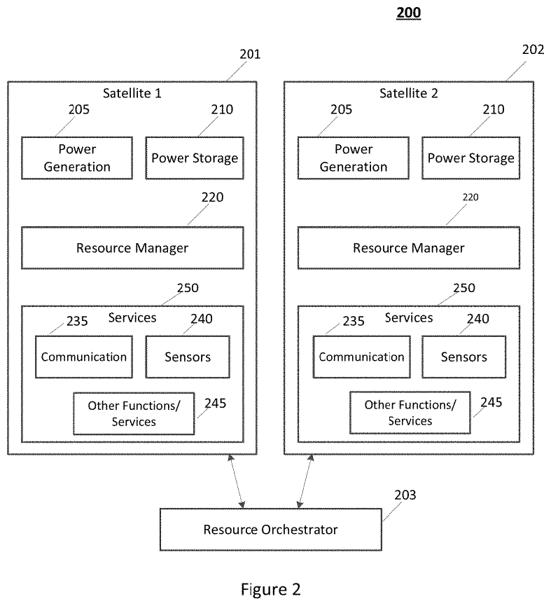

FIG. 2 shows an exemplary satellite system 200 with two satellites 201 and 202 which communicate with a Resource Orchestrator 203, according to an aspect. In an aspect, satellite 201 and satellite 202 are similar to each other as would be the case, for instance, in a LEO communications satellite system. Each satellite 201 and 202 has capabilities such as power generation 205 and power storage 210. Satellites 201 and 202 also provide services 250, such as communications equipment 235 and sensors 240 which may be, for instance, cameras for mapping. Communications equipment 235 and sensors 240 are used as an example only. Other services or mixes of services and functionality 245 are possible. One skilled in the art would understand that there may be other functional capabilities including computing resources, storage memory, and sensors provided in satellites 201 and 202, other than those providing services such as sensors for determining location. Power generation 205 and power storage 210 provide power as a resource to the other capabilities and services 250. Satellites are shown as an embodiment.

A Resource Manager 220 on each satellite 201, 202 manages the power system of the satellite comprising power generation 205 and power storage 210, for instance, a solar array and battery, respectively. Resource Manager 220 functions may include measuring, tracking, computing, and communicating the generation and storage related characteristics, some of which may be optional. Resource Manager 220 may determine current power generation state and future predicted power generation capability, which can be based on information obtained from Power Generation 205. Resource Manager 220 may determine current battery charge state, future predicted battery charge state, and current and future predicted battery condition, which can be based on information obtained from Power Storage 210.

Resource Manager 220 functions may also include measuring, tracking, predicting, and communicating the local power allocation characteristics such as power allocation and distribution, power consumption monitoring, prediction of future power needs.

Functions of the Resource Manager 220 may operate local to the device, for instance on a satellite, or remotely from the device, for instance on a terrestrial cloud server.

Resource Orchestrator 203 determines the allocation of power across two or more satellites, each of which is managed by a Resource Manager 220. Resource Orchestrator 203 functions may include receiving energy reports and local service reports (which may instead be combined into one device report) from two or more Resource Managers 220, determining a future service map and future energy grants, sending a future service map and/or energy grant to Resource Managers 220 thereby defining a set of customers to serve in a future service period and an energy use schedule.

Some functions of Resource Orchestrator 203 may operate co-located to one or more devices, for instance in a satellite payload, or may operate on terrestrial equipment, for instance cloud servers, or a hybrid configuration of the two.

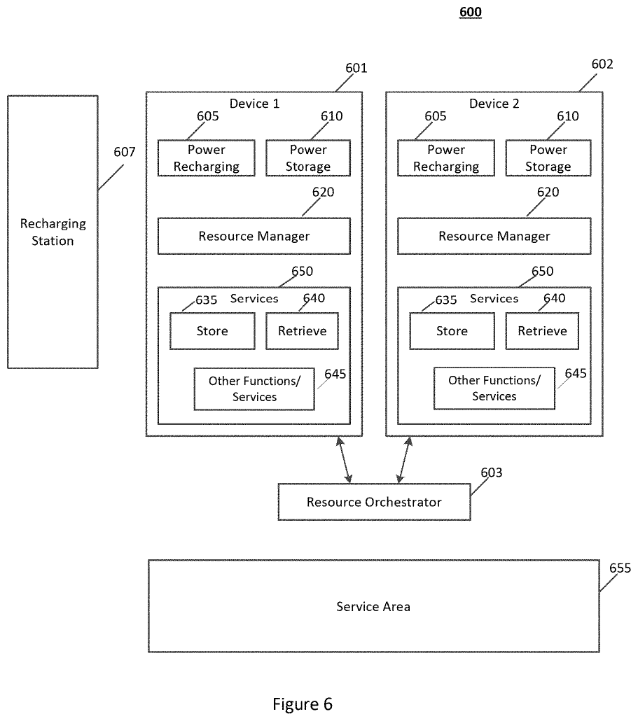

FIG. 6 shows an exemplary IoT system 600 with two IoT devices 601 and 602 which communicate with a Resource Orchestrator 603, according to an aspect. In the example shown in FIG. 6, device 601 and device 602 are similar to each other as would be the case, for instance, in a warehouse that is equipped with multiple robots that are used to stock the shelves and retrieve items from the shelves.

As with the satellites 201 and 202 in FIG. 2, each device 601, 602 has power storage 610, a resource manager 620, and Services 650. In an aspect, devices 601 and 602 may be robots used for stocking items (customer items) on shelves and retrieving such items from shelves in a warehouse or other setting. In this example, Services 650 may be comprised of a store operation 635 in which the robot stores customer items in the warehouse shelves and a retrieve operation 640 in which the robot retrieves customer items from the warehouse shelves. Services 650 also comprises other services/functions 645. One skilled in the art would understand that different devices in different scenarios would have different services offered. For instance, in various aspects the devices may be autonomous delivery, transit, ride-share, or dedicated-ride vehicles and the services provided may be comprised of a pickup operation and a drop-off operation, among other services.

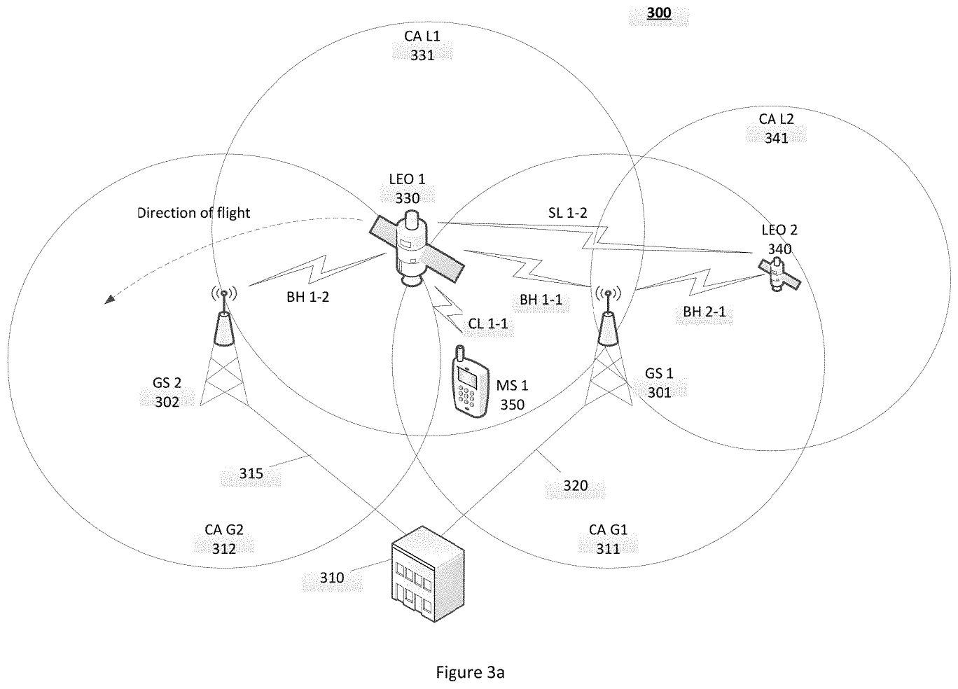

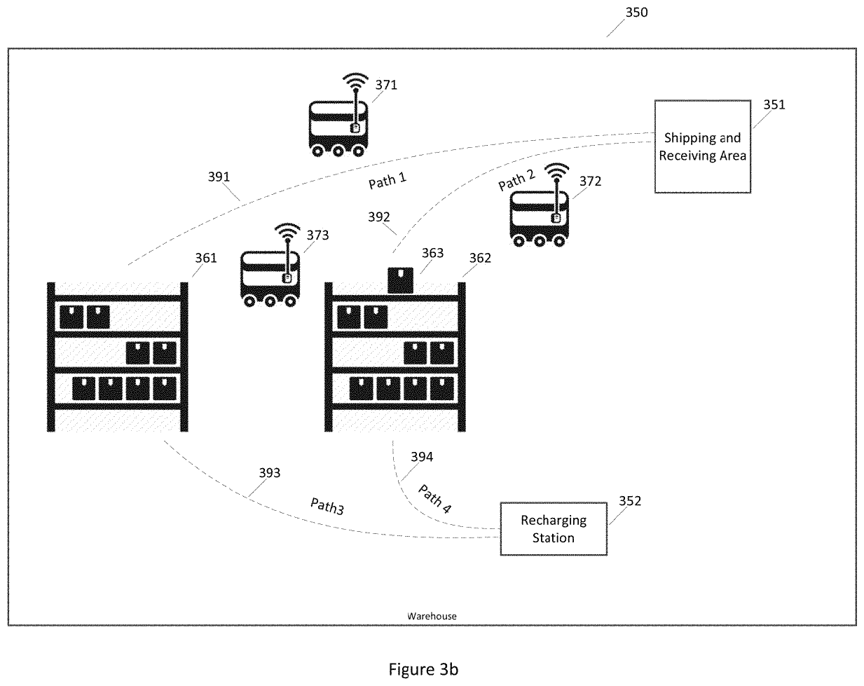

Resource manager 620 of each device 601, 602 is in communication with resource orchestrator 603. Devices 601 and 602 each have a power recharging capability 605 that allows them to recharge from external recharging station(s) 607. Recharging station 607 may be shared by two or more devices 601, 602. There may be fewer recharging stations 607 than devices 601, 602, thereby forcing sharing of one or more recharging stations 607. Alternatively, there may be the same number or more recharging stations 607 as devices 601, 602 and the need to share is dependent upon the placement of recharging stations 607 around service area 655. Service area 655 is the geographical (e.g., floor) or functional (e.g., top shelves vs. bottom shelves, trucks vs. boxcars) area covered by a set of devices 601 and 602. Service area 655 may itself be considered a “customer item” to be serviced by one or more of devices 601 and 602, and/or each of the items within service area 655 (such as merchandise items or warehouse items) may be considered a “customer item” to be serviced by one or more of devices 601 and 602. Each device may have the capability to cover all or a portion of service area 655. The portion of service area 655 covered by a single device is called that device's coverage area, similar to that of ground stations or satellites in the embodiment(s) referenced in FIGS. 2 and 3a. The portions of service area 655 covered by devices 601 and 602, for instances the bins or shelves serviced by each, may overlap.

It is advantageous for devices 601 and 602 to avoid running out of power or to have a power level that is too low to perform certain operations, such as reaching for a high shelf, safely. It is also advantageous for devices 601 and 602 to avoid sitting idle while waiting for availability of a charging station 607. It is advantageous for devices 601 and 602, along with any other such devices, to not leave a part of the service area unserved.

Resource Orchestrator 603 determines the charging schedule for two or more devices 601, 602, each managed by a Resource Manager 620. Resource Orchestrator 603 functions may include receiving energy reports and local service reports (which may instead be combined into a device report) from two or more Resource Managers 620, determining future service maps and charging schedules, sending future service maps and charging schedules to Resource Managers 620 thereby defining a set of customers to serve in a future service period and an energy use schedule. Charging schedules may be part of the future service maps or may be separate messages between Resource Orchestrator 603 and the Resource Managers 620.

Some functions of Resource Orchestrator 603 may operate co-located to one or more devices or may operate on terrestrial equipment, for instance in local servers in the warehouse, cloud servers, or a hybrid configuration of two or more of these options.

### Cooperative Operation

In an aspect, a fleet of devices which provide one or more services (e.g., Internet connectivity) and can serve a common customer or region (e.g., “customer items”) may coordinate power usage to maximize the efficiency and value of service offerings. For example, such power usage coordination can take place among two LEO satellites, each providing internet connectivity to their customers, with orbits and communication coverage that overlap.

FIG. 3a shows such a scenario of a system 300 comprising two LEO satellites 330 and 340, each providing internet connectivity to their customers, with orbits and communication coverage that overlap and having ground stations with overlapping coverage area. As seen in FIG. 3a, ground stations GS1 301 and GS2 302 have coverage areas CAG1 311 and CAG2 312, respectively. In an aspect, these coverage areas overlap so that satellites passing from one coverage area to the next may hand over from one ground station to the next without disruption of communications. Ground stations GS1 301 and GS2 302 may be in communication with a network operation center 310 via communication links 315 and 320, respectively.

Similarly, satellites LEO1 330 and LEO2 340 have coverage areas CAL1 331 and CAL2 341, respectively. In an aspect, these coverage areas overlap so that mobile stations, such as mobile station MS1 350, may hand over from one satellite to the next as they pass overhead without disruption of communications. Additionally, the number of satellites in a constellation and their orbital parameters may cause two or more satellites to, at times, have substantially overlapping instantaneous coverage. Note that the above examples are described using only a single mobile station. However, a person skilled in the art would understand that a satellite may be in communication with zero or more mobile stations at any point in time.

In an aspect, devices work in cooperation to maximize the value of service to customers (maximize customer bandwidth, uptime, etc.) and to minimize the cost (e.g., use of power, risk of outage, risk of device power brownout, damage to device battery).

In an aspect, two devices, such as LEO1 330 and LEO2 340, provide overlapping geographical coverage as shown in FIG. 3a. In this example, each of LEO1 330 and LEO2 340 has power generation 205 and power storage 210, provides communications 235 services, and has a Resource Manager 220. Resource Orchestrator 203 resides in network operation center 310 with connectivity access to each LEO Resource Manager 220 through ground stations GS1 301 and GS2 302. In an aspect, network operation center 310 is a terrestrial cloud service. In an alternative aspect, network operation center 310 may be collocated with a ground station or may be distributed across multiple ground stations.

FIG. 3b shows a similar scenario of an IoT system comprising multiple robotic devices that store and/or retrieve items (which are considered to be “customer items”) in a warehouse 350. Robotic devices 371, 372, and 373 retrieve items 363 from shipping and receiving area 351 via paths 391 and 392. Items 363 are placed by robotic devices 371, 372 and 373 on shelves 361 and 362. Robotic devices 371, 372, and 373 may also retrieve items 363 from shelves 361 and 362 and return them to shipping and receiving area 351 via paths 391 and 392, or via different paths. Many scenarios are possible. In an aspect, Robotic devices 371, 372, and 373 retrieve items 363 from shipping and receiving area 351, place them on shelves 361 and 362, and then return them to shipping and receiving area 351 to be shipped elsewhere. Robotic devices 371, 372, and 373 may have identical or varying coverage areas within the warehouse service area 350 or may have varying functionality such as stocking shelves or retrieving from shelves. In a different aspect, Robotic devices 371, 372, and 373 retrieve items 363 from shipping and receiving area 351, place them on shelves 361 and 362, and then retrieve them when necessary to be used in facilities served by the warehouse, such as a manufacturing facility or service (e.g., automotive or airplane repair) facility. In a different aspect, Robotic devices 371, 372, and 373 retrieve items 363 from a facility served by the warehouse, such as a manufacturing facility, place them on shelves 361 and 362, and later retrieve them from shelves 361 and 362 and take them to shipping and receiving area 351. One skilled in the art would understand that many scenarios with a variety of paths and a variety of devices with possibly varying abilities and responsibilities are possible.

Robotic devices 371, 372, and 373 share recharging station 352 which is accessed via paths 393 and 394. Based on predicted future demand for services, for instance knowledge of when various items 363 (e.g., “customer items”) will arrive on a truck to shipping and receiving area 351, Resource Orchestrator 603 may create future service maps including charging schedules for robotic devices 371, 372, and 373. The future service maps may be created based upon information such as paths 391, 392, 393, and 394 and on the energy required to traverse them; items 363, their weight, their destination on shelves 361 and 362, their subsequent destination (e.g., manufacturing facility); the energy consumption of robotic devices 371, 372, and 373; and the recharging times (e.g., recharging time required) for robotic devices 371, 372, and 373. The future service maps, optionally customized for each of robotic devices 371, 372, and 373, are transferred from Resource Orchestrator 603 to the Resource Manager 620 for each of robotic devices 371, 372, and 373.

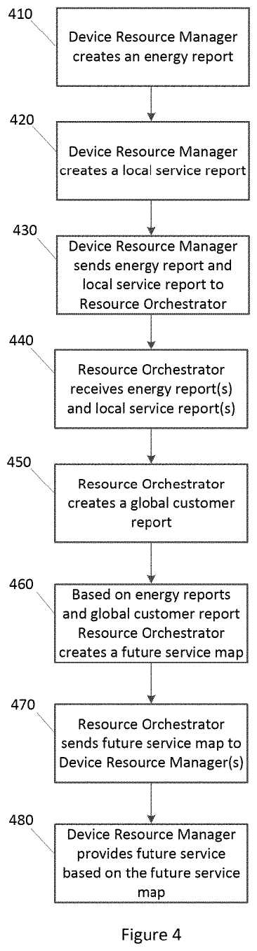

FIG. 4 is a flowchart depicting a method for orchestrating and scheduling device service based on device energy requirements and resources according to aspects of the invention. The method of FIG. 4 may be performed periodically. In step 410, each device Resource Manager (e.g., 220 or 620) creates an energy report covering a current service period (e.g., a current 5-minute period duration which began at 0830 GMT). The energy report includes information on the current ability of the associated device to generate or recharge power (e.g., a “recharge energy capability” or an “recharge energy capability amount” such as, for example, 250 watts via power generation 205 solar array or needing 10 minutes to charge to full capacity at charging station 607) and on the currently available amount of stored power (e.g., “current remaining energy level”, such as, for example, 100 watt-hours stored in the power storage 210 or 610) for the associated device.

The energy report may also include information necessary to predict a future energy state of the associated device. For example, a LEO energy report may include information on whether the LEO will be transitioning from sunlight to darkness and when (e.g., a “recharge blackout time”). An energy report for a device which must travel to a recharging location (e.g., floor cleaning robot, autonomous car), may also include the time, distance, and energy required (e.g., “energy to begin recharge”) to reach the recharging location.

The energy report may also include the amount of energy needed to support future service assignments (e.g., “energy to perform service task”). For example, for a LEO providing communications, the energy report may include a vector describing the number of milli-watt hours consumed by a LEO per megabyte transferred as a function of RF transmit power and parameters, such as modulation. In another example, for a floor cleaning robot, the energy report may include a value describing the amount of energy needed to clean a defined area (e.g., 100 sq m). An energy report for robotic devices 371, 372 and 373 of FIG. 3b may include the amount of energy used to travel along a certain path (e.g., Path 1 on 391 or Path 2 on 392). Alternately, an energy report may include the amount of energy used to travel a unit distance along any path (e.g., 1 milliwatt-hour/foot of floor traversed).

In an alternative aspect, the information necessary to predict a future energy state based on a future level of service is known in advance, such as in a stored file or table, by Resource Orchestrator 203 and is not required to be sent by the Resource Manager 220.

In step 420, each Resource Manager 220 or 620 creates a local service report for the Resource Orchestrator 203 or 603 for the current service period. As mentioned above, in an alternate aspect, an energy report and a local service report may be combined into a single “device report” by Resource Manager 220, 620, in which case steps 410 and 420 are combined. The local service report may include the customer locations, customer IDs, customer subscription types, and additional details pertaining to the service provided and the service configuration and operation (e.g., “service operation parameters”) for each customer. For example, for a LEO providing communication, the local service report may include the following information, per customer: the amount of data transmitted and received during the current period, the TX/RX modulation, antenna configuration, RF link budget, and the type of application being used by the customer, for instance streaming video, best effort data, or voice. In another example referring to FIG. 3b, a local service report for robotic devices 371, 372 and 373 may include paths traveled (e.g., path 391), items 363 retrieved or current position.

In step 430, Resource Manager 220 or 620 sends the energy report and local service report, or in the alternative a single combined device report, to the Resource Orchestrator 203 or 603. One skilled in the art would appreciate that step 430 may be incorporated in steps 410 and 420.

In step 440, Resource Orchestrator 203 or 603 receives the reports sent by Resource Managers 220 or 620.

In step 450, Resource Orchestrator 203 creates a global customer report by aggregating the local service reports sent by each Resource Manager 220 or 620 associated with each device. For a LEO providing communication, an active customer item, such as a mobile station, may be defined as those with one or more ongoing data connections, such as an HTTP/TCP session, in the current service period. An inactive customer item may be defined as those with active subscription but with no current data connections or data transfer. For a warehouse, an active customer item may be an item that is delivered or shipped during the current service period. An inactive customer item may be an item that is neither delivered nor shipped during the current service period but that sits in a bin or on a shelf in the warehouse. A global customer report may include both active and inactive customer items.

In an aspect, a global customer report may also include predictions as to the likelihood that an inactive customer item may become an active customer item, or vice versa, in a future service period. This prediction may be based on historical data. For example, data may be stored indicating that a customer item frequently displays a Netflix movie on most Friday evenings at around 7 pm.

In step 460, Resource Orchestrator 203 or 603 determines a future service map wherein each customer is assigned to a device along with recommended service configuration for a future service time period. The determination of the future service map may be governed by the Class 1 and Class 2 procedures explained in detail below. In step 470, Resource Orchestrator 203 or 603 sends the future service map to the Resource Manager 220 associated with each device. In step 480, when the future service time period begins, Resource Manager 220 or 620 initiates service by the associated device to certain customers according to the future service map.

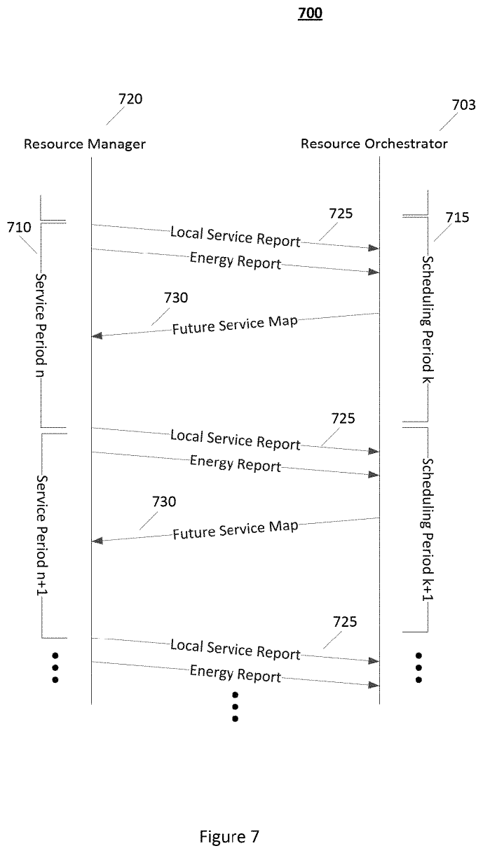

FIG. 7 shows ladder diagram 700 which depicts the message flow between a Resource Orchestrator 703 and one of Resource Managers 720, according to an aspect. This message flow protocol may be used with any of the aspects described above. After each service period n 710, Resource Manager 720 creates a local service report and an energy report 725 for service period n 710 and then transmits them to Resource Orchestrator 703. As mentioned above, in an alternate aspect the local service report and an energy report 725 may be combined into a single device report 725 for service period n 710 which is transmitted to Resource Orchestrator 703. Note that local service report and energy report 725 may be a single message or multiple messages. During each scheduling period k 715 and based in part on one or more previously received local service reports and energy reports 725, Resource Orchestrator 703 sends a future service map 730 for a future service period, such as for example service period n+1. This process then repeats in which Resource Manager 720 creates local service reports and energy reports 725 (or a single combined device report 725) and transmits them to Resource Orchestrator 703 and in which Resource Orchestrator 703 creates future service maps 730 and transmits them to Resource Manager 720. Note that service periods 710 and scheduling periods 715 may or may not be of the same time duration and may or may not be time aligned. Local service reports 725 may be generated and transmitted more or less often than future service maps 730. A future service map 730 may cover more than one service period 710. In an aspect, both local service reports 725 and future service maps 730 may be occasionally generated and transmitted aperiodically, for instance if some event, such as the malfunctioning of a device, triggers an urgent update of information.

Future service maps may also indicate a time ordering of serving customers by a device. For instance, a LEO satellite may use less power by waiting until it is closer to a customer item (such as a mobile station), thereby providing better physical layer characteristics and allowing more efficient transfer of data. The set of customer items indicated in the future service map may be ordered by most efficient service time and may even have gaps during which no customer item is serviced. In a warehouse scenario, a customer item may be ordered for retrieval or delivery in the future service map. For instance, if the warehouse is supporting a manufacturing facility or a repair facility, items may need to be moved from the warehouse to the supported facility in the order needed, which may be different than the most efficient order. Similarly, when loading trucks, the future service map may take into account when trucks are scheduled to leave, the size and shape of items to be loaded, the weight of items being loaded, etc. Similar ordering constraints can apply when unloading trucks.

### Class 1 Procedures

In an aspect, the procedure to determine the future service map begins by determining the set of potential devices within a system that are capable of serving each customer item in a future service period. For the LEO example, this may be determined by having knowledge, such as stored or accessible data, of each LEO orbital path and antenna coverage pattern.

For the warehouse example, the procedure to determine the future service map begins by determining the set of customer items 363 needed to be retrieved or moved during the next service period and which robotic devices are capable of serving such items. For example, a robotic device may be considered capable of serving an item 363 if it is within a certain distance (below a threshold of 50 m, for example), and is able to complete the service of item 363 given its shape, size, and/or weight.

In an aspect, a charging schedule is determined in advance of the future service map determination procedure described above. A charging schedule may be determined by Resource Orchestrator 603 by inspecting the energy report from each robotic device according to the following procedure:
Step 1: Sort robotic devices by current battery charge level;
Step 2: Starting with the robotic device having the lowest charge level, determine if the battery charge level for a robotic device is below a threshold, for example 20%. If so, then the robotic device is assigned to its nearest charging station, via a charging schedule that is transmitted to the associated Resource Manager 620 for that device, for one or more future service periods; and
Step 3: Repeat step 2 for the robotic device with the next lowest battery charge level, until all robotic devices have been considered.

Next, Resource Orchestrator 203 (or 603) assigns each potential active and inactive customer item to a device for the future service period, based on each device's amount of energy available to serve customer items in a future service period and (optionally) the amount of energy needed to serve each customer item by the associated device.

In an aspect, each device is assigned a quantity of customer items proportional to the amount of energy reported available by the device in a future service period. For example, in the case of two LEOs with overlapping coverage areas, LEO1 may have 75 watt-hours available to power data communications whereas LEO2 may have only 25 watt-hours available. If over the next service interval (e.g., 5 minutes) there are 1,000 potential customers to serve, then LEO1 may be assigned 750 customer items while LEO2 may be assigned 250 potential customer items based on the available energy per device.

In an aspect, each device is assigned a quantity of potential customer items proportional to the amount of available energy reported by the devices during a future service period which is above a threshold value. Let cₜₒₜ be the total potential customer items in a service area. Let power, be the available power for device i. Let thresh, be the threshold value for device 1, and let n denote the number of devices being considered. Then the number of customer items for device k, denoted cₖ, is given by the following Equation 1:

$${c}_{k} = {c}_{tot} * ( {power}_{k} - {thresh}_{k} ) / {\sum }_{i = 1}^{n} ( {power}_{i} - {thresh}_{i} ) \qquad Equation 1$$

Using the previous example, a minimum threshold of 20 watt-hours for all devices may be applied. In such a scenario, based on Equation 1, LEO1 may be assigned 917 customer items cₖ=1000*(75 W−20 W)/[(75 W−20 W)+(25 W−20 W)] and LEO2 may be assigned 83 customer items.

In an aspect, a limit is placed on the maximum number of customer items which can be served by a device during a future service period. This limit may correspond to a typical limit that is imposed on the number of concurrent satellite connections to a “base station”. For example, a LEO1 may only be capable of serving a maximum of 750 customer items during a 5-minute service interval due to a maximum amount of communication bandwidth. Referring to the previous example, this would then result in LEO1 being assigned 750 customer items and LEO2 being assigned 83 customer items. The remaining customer items may be without service for this service interval.

In an aspect, the limit placed on the maximum number of customer items which can be served by a device is a function of the amount of available energy reported by the device and the amount of energy required to serve each customer item. For example, it may be established that each served LEO customer item, on average, requires 0.05 watt-hour over a service period of 5 minutes. Referring to our previous example, per Equation 1, this would establish a maximum number of customer items served by LEO1 of (75−20)/0.05=1100 customer items and by LEO2 of (25−20)/0.05=100 customer items.

In an aspect, Resource Orchestrator 203 calculates the maximum limit using multiple methods and then applies the lowest calculated maximum limit. For instance, an individual LEO may be able to serve a maximum number of customer items based on power resources as described above and may have a different maximum limit based on available communication bandwidth resources.

In an aspect, Resource Orchestrator 203 assigns some or all of the customer items unable to be served by a particular device, due to the application of a maximum limit, to a different device which has not yet reached a maximum limit following the proportional assignment described above. Referring to the example above, LEO1 service was capped at 750 customer items thereby leaving 167 customer items (917-750) potentially unassigned. A subset of 17 of those customer items may be assigned to LEO2 as the proportional assignment of 83 customer items is 17 customer items below its threshold of 100.

### Class 2 Procedures

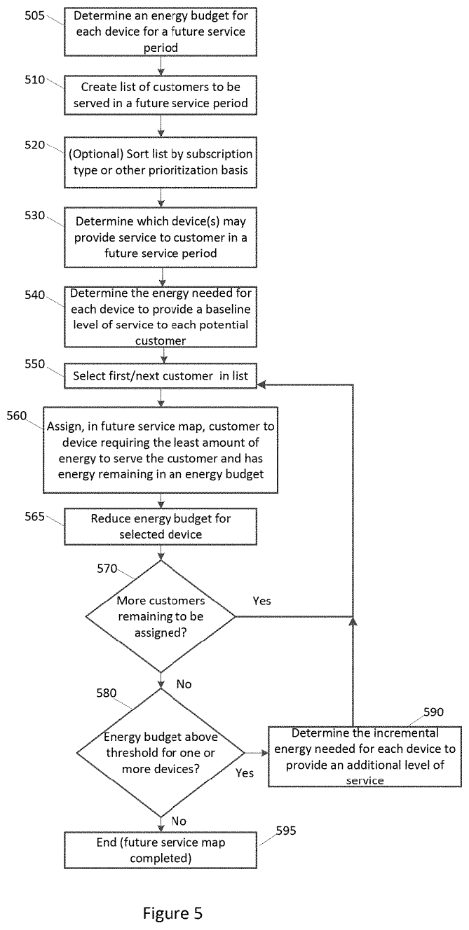

In an aspect, referring to FIG. 7, Resource Orchestrator 703 determines a future service map 730 based upon the available energy of a device in a future service period 710 (an “energy budget”), the energy required by each device to serve a customer item and/or the quantity or quality of service provided to the customer item. For example, a future service map may be determined using a process shown in the flowchart depicted in FIG. 5, according to an aspect.

In step 505 of FIG. 5, Resource Orchestrator 703 determines an energy budget (e.g., in units of watt-hours) for each device for a future service period 710. The energy budget may be determined using an energy report 725 sent from a device's Resource Manager 720. The energy budget defines the amount of energy which may be used by the associated device to service customer items in a future service period 710. The energy budget may not necessarily include the energy needed to sustain device operations not directly tied to service of a customer item (e.g., LEO navigation or heating systems). In an aspect, the energy budget may be computed based on a combination of the current power storage charge level of the device and the current and predicted future ability to generate power (or recharge power storage) by the device. The energy budget may be calculated to ensure that some reserve energy is available for the device to serve unanticipated customer items (e.g., inactive customer items that become active, or active customer items that increase the amount of desired service).

In step 510, a list of potential customer items to be served in a future service period 710 is created. This list may be created using local service reports 725 sent from Resource Managers 720 or via a subscription database.

In step 520, an optional step is performed to sort the customer item list by customer subscription type. For example, a subscription might include, from highest priority service to the lowest priority service, gold, silver, and bronze service levels. The list may be sorted so that gold customers are at the top of the list. Sorting may instead, or in addition, be performed based on some other attribute. For instance, customer items may be sorted in order of expected physical layer parameters effecting energy per quantity of data transferred, such as in order of highest to lowest modulation level expected to be needed for the customer item to communicate with the LEO. In an aspect, customer items may be sorted in order of quality of service (QoS) requirements of their expected data.

In step 530, Resource Orchestrator 703 determines which device(s) may provide service to a customer item in a future service period 710. This may be determined using the global customer report. In the example of LEO-based connectivity service, this determination may be further based on known orbital positions and trajectories. In the example of robotic devices in a warehouse, this may be determined by the proximity of the robotic device to the customer item (e.g., item 363). Optionally, in this step the Resource Orchestrator 703 may assign the n devices having the lowest charge level to the n open and available recharging stations 607 in lieu of assigning those devices to one or more customers items.

In step 540, Resource Orchestrator 703 determines the energy needed for each device to provide a baseline level of service to each potential customer item. A baseline level of service may, for example, be a baseline amount of data transferred between a LEO device and the customer item during a future service period 710 (e.g., 50 MB). In the example of robotic devices in a warehouse, a baseline level of service might be the amount of energy required to retrieve an item 363 from shelf 361 and transport it to shipping/receiving area 351.

The energy needed to provide such a baseline level of service may be determined by the specifics of the device. In the example of LEO communications, a LEO typical transmit power and communications radio power consumption may be used to compute the energy needed to compute a baseline level of service. The energy needed may also include the effect of an RF link budget between the device and customer item. For example, LEO1 may require twice as much transmit power to reach a particular customer item versus LEO2. In this case, the total energy needed to provide a baseline level of service to that customer item may be 50% higher for LEO1 versus LEO2, because transmit power is a large component of the overall LEO power budget. The RF link budget may be determined via local service reports.

In step 550 a loop is initiated to begin the process of building the future service map. In the first iteration through the loop, the first customer item in the customer list is selected.

In step 560, the customer item is assigned to a device (i.e., designated to be served by a device): (a) which requires the least amount of energy to serve the customer item; and (b) for which the device has energy remaining in its energy budget. The assignment of the device to the customer is stored in the future service map. In step 565, the device energy budget is reduced for the device designated in step 560 by the amount of energy needed to serve the customer item. In step 570, the customer list is inspected to determine if there are additional customer items remaining to be assigned to a device. If yes, then the process loops back to step 550 in which the next customer item on the customer list is selected. If no, then the process proceeds to step 580.

In step 580, the remaining energy budget of each device is inspected across all devices. If no devices have any remaining energy budget above a threshold, then the process is completed at the end 595. Optionally in step 580, if no devices have any remaining energy budget, then Resource Orchestrator 703 assigns those devices having no assigned customers to the nearest recharging station 607, if available or possible.

If one or more devices have some remaining energy budget above a threshold, then the process proceeds to step 590 in which Resource Orchestrator 703 determines the incremental energy needed for each device to provide an additional level of service (i.e., a service amount beyond baseline) to each customer item of the associated device. For example, Resource Orchestrator 703 may calculate the amount of energy needed for a device to provide an additional 50 MB of data communications to each of its customer items. In an alternate example, Resource Orchestrator 703 may determine the amount of energy needed for a robotic device to operate at a higher speed to deliver item 363 to shipping/receiving area 351. The process then proceeds to step 550 where the loop is started again for the next customer item in the customer list.

### Further Class 2 Enhancements

In step 590 of FIG. 5, Resource Orchestrator 703 may calculate the energy needed for each device to provide an incremental amount of service (e.g., 50 MB) as well as an enhanced quality of service (e.g., with latency or jitter less than a time threshold) for each customer item served by that device.

In step 520 of FIG. 5, the customer list may also be sorted based on the prediction of whether a customer item is active or inactive. This prediction may be based on a query of the global customer report.

In step 540 of FIG. 5, the baseline level of service may be a function of subscription type associated with the customer item. For example, the baseline level of service for a gold customer may be 100 MB whereas the baseline level of service for a silver or bronze customer may only be 50 MB. A similar approach may be used to create more than one “additional levels of service” in step 590.

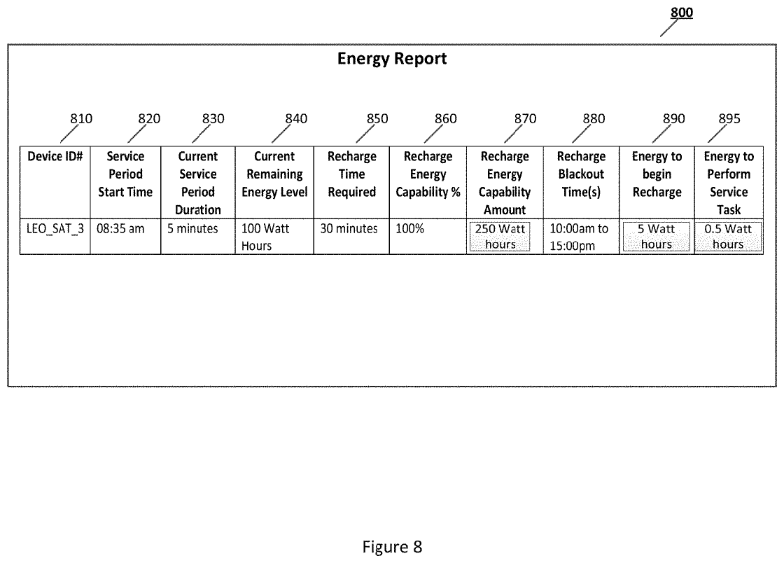

FIG. 8 is a diagram depicting an energy report according to an aspect of the invention. As mentioned in examples provided above, an energy report is generated by a resource manager in a device, such as resource manager 220, 620 of FIGS. 2 and 6, respectively. As seen in FIG. 8, energy report 800 consists of 10 data fields, although this is only one example of an energy report and more or less data fields can be provided therein. Turning now to the data fields provided in energy report 800, Device ID #810 is provided to identify the particular device that is generating the energy report and in this example it has a value of LEO_SAT_3. Service Period Start Time 820 is provided to indicate the start time of the time period for which the energy report is generated and in this example it has a value of 08:35 am. Current Service Period Duration 830 is provided to indicate the time duration of the time period for which the energy report is generated and in this example it has a value of 5 minutes. Current Remaining Energy Level 840 is provided to indicate the remaining energy level of the device and in this example it has a value of 100 Watt hours, although other units of power/energy may be used. Recharge Time Required 850 is provided to indicate the amount of time required for the device to recharge its power supply to a specific amount, such as the recharge energy capability shown in the next several data fields, and in this example it has a value of 30 minutes.

Recharge Energy Capability % 860 is provided to indicate the level of energy that the power supply is currently capable of being recharged to, and in this example it has a value of 100%. Recharge Energy Capability Amount 870 is provided to indicate the amount of energy that the power supply is currently capable of being recharged to, and in this example it has a value of 250 Watt hours. Recharge Blackout Time(s) 880 is provided to indicate the time (or times for multiple instances) during which the device is not capable of recharging, such as when a satellite passes out of sunlight into darkness, and in this example it has a value of 10:00 am to 15:00 pm (indicating, for example that a satellite is in darkness during this time). Energy To Begin Recharge 890 is provided to indicate the amount of energy that will be required by the device to prepare and/or get into position for starting a recharge process, such as when a satellite needs to change its angle for the solar panels to recharge the power supply or such as the energy required by a robotic device to travel to a recharging station. In this example, Energy To Begin Recharge 890 has a value of 5 Watt hours. Energy To Perform Service Task 895 is provided to indicate the amount of energy (such as in units of Watt hours) required by the device to perform a discrete task. For example, in the case of a LEO satellite that is providing communication services, this data field may include a vector describing the number of milli-watt hours consumed by the satellite per megabyte transferred as a function of RF transmit power and parameters, such as modulation. In another example, in the case of a floor cleaning robot (or other robotic device), this data field may include a value describing the amount of energy needed to clean a defined area (e.g., 100 sq m), or may include the amount of energy used to travel along a certain path. Alternatively, this data field may include the amount of energy used to travel a unit distance along a path (e.g., 1 milliwatt-hour/foot of floor traversed). As mentioned above, energy report 800 of FIG. 8 is provided as an example and it should be appreciated that more or less data fields can be provided in the energy report, that different data fields can be used in the energy report for different types of devices and/or services, and that the energy report can be broken into individual data segments for storage and/or transmission. Also, as mentioned above, the energy report can be combined with the local service report into a single device report.

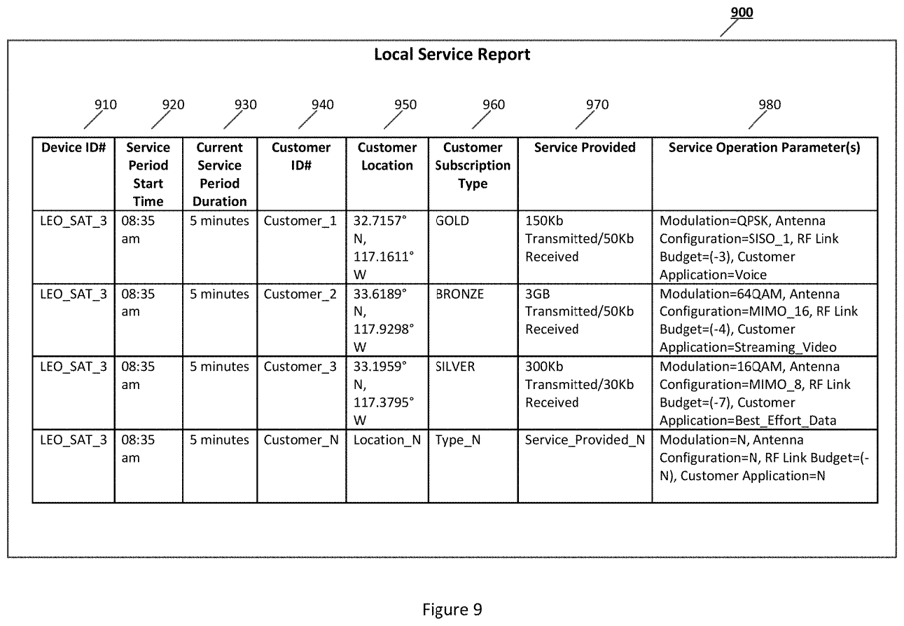

FIG. 9 is a diagram depicting a local service report according to an aspect of the invention. As mentioned in the examples provided above, a local service report is generated by a resource manager in a device, such as resource manager 220, 620 of FIGS. 2 and 6, respectively. As seen in FIG. 9, the local service report 900 consists of 8 data fields, although this is only one example of a local service report and more or less data fields can be provided therein. Turning now to the data fields provided in local service report 900, Device ID #910 is provided to identify the particular device that is generating the local service report and in this example it has a value of LEO_SAT_3. Service Period Start Time 920 is provided to indicate the start time of the time period for which the local service report is generated and in this example it has a value of 08:35 am. Current Service Period Duration 930 is provided to indicate the time duration of the time period for which the local service report is generated and in this example it has a value of 5 minutes. Customer ID #940 is provided to indicate a particular customer item that was assigned to this device for being provided with a service from the device for the Current Service Period Duration. As seen in in the rows for this data field, Customer_1, Customer_2, Customer_3, and Customer_N were assigned to this device for service during the service period to illustrate that many customer items can be assigned to a given device for service, such as for communication service from a particular satellite or for storage/retrieval service from a robotic device, for example.

Customer Location 950 is provided to indicate the location associated with each particular customer item, which in this example is shown in latitude/longitude coordinates but could be provided in other units as well. Customer Subscription Type 960 is provided to indicate the type of subscription that is associated with each particular customer item, such as GOLD, SILVER or BRONZE in descending order of service priority. Other types of service subscription could also be used in this field. Service Provided 970 is provided to indicate the amount of service provided to the associated customer item during the service period, which in this example is shown in terms of bytes transmitted/received. Of course, for other devices and other services a different service amount parameter and/or units could be used. For example, in the case of a robotic device, the Service Provided could be shown in terms of customer items stored and/or retrieved. Service Operation Parameter(s) 980 is provided to indicate the service operational parameters associated with the service that was provided to the customer item during the service period, which in this example is shown in terms of Tx/Rx Modulation type, antenna configuration mode, RF link budget value, and the type of application being used by the customer item, for instance streaming video, best effort data, or voice. Of course, for other devices and other services different Service Operation Parameters could be used. For example, in the case of a robotic device, the Service Operation Parameters 980 could be shown in terms of paths traveled by the device, items stored/retrieved by the device, speed of device operation, or a current position of the device. Local service report 900 may also contain entries for customers requesting or needing service during the service period but were unable to be served due to lack of resources or some other issue. In this case, Service Provided field 970 may indicate that no service was provided, and Service Operation Parameters 980 may indicate the reason why no service was provided. As mentioned above, local service report 900 of FIG. 9 is provided as an example and it should be appreciated that more or less data fields can be provided in the local service report, that different data fields can be used in the local service report for different types of devices and/or services, and that the local service report can be broken into individual data segments for storage and/or transmission. Also, as mentioned above, the energy report can be combined with the local service report into a single device report.

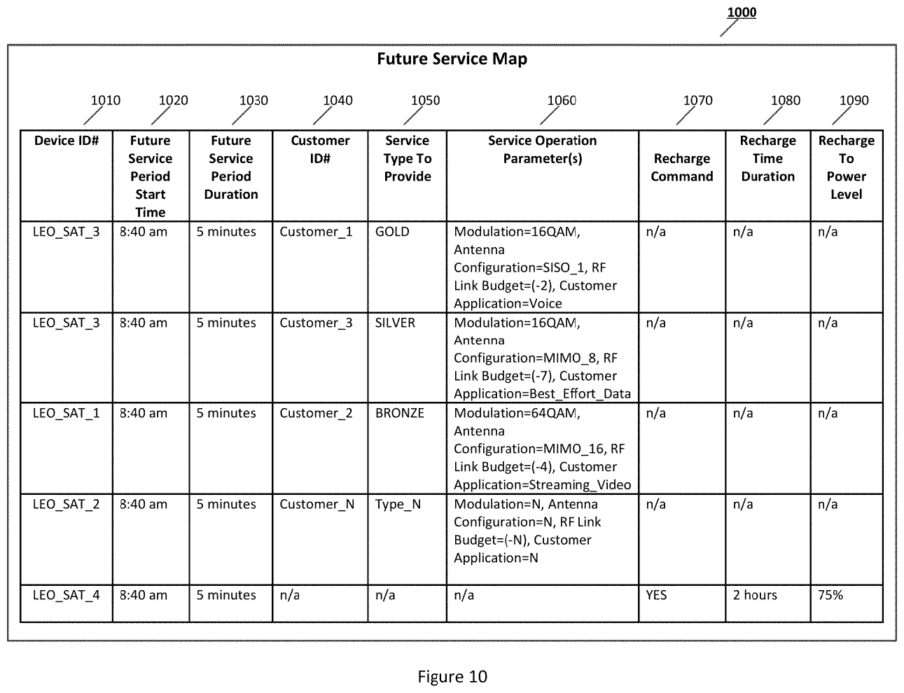

FIG. 10 is a diagram depicting a future service map according to an aspect of the invention. As mentioned in the examples provided above, a future service map is generated by a resource orchestrator, such as Resource Orchestrator 203, 603 of FIGS. 2 and 6, respectively. As seen in FIG. 10, the future service map 1000 consists of 9 data fields, although this is only one example of a future service map and more or less data fields can be provided therein. Turning now to the data fields provided in future service map 1000, Device ID #1010 is provided to identify the particular device associated with the data in that particular row and in this example it can be seen that the various rows of this data field include LEO_SAT_3, LEO_SAT_1, LEO_SAT_2 and LEO_SAT_4 to show that four different devices are designated in this particular example of a future service map. Future Service Period Start Time 1020 is provided to indicate the start time of the future time period for which this future service map is generated and in this example it has a value of 08:40 am. Future Service Period Duration 1030 is provided to indicate the time duration of the future time period for which this future service map 1000 is generated and in this example it has a value of 5 minutes. Customer ID #1040 is provided to indicate a particular customer item that is assigned to the device indicated in Device ID #1010 for being provided with a service from the device for the Future Service Period Duration 1030. As seen in in the rows for this data field, Customer_1, Customer_3, Customer_2, and Customer_N are assigned to different devices for service during the future service period. As seen in the last row of future service map 1000, the device LEO_SAT_4 does not have an assigned customer item because it is being assigned to recharge during this future time period.

Service Type To Provide 1050 is provided to indicate the type of subscription service that the assigned device should provide to the corresponding customer item during the future time period, such as GOLD, SILVER or BRONZE in descending order of service priority. Other types of service subscription could also be used in this field. Service Operation Parameter(s) 1060 is provided to indicate the service operational parameters that should be utilized by the associated device to provide service to the associated customer item during the future service period. In this example this data field is shown in terms of Tx/Rx Modulation type, antenna configuration mode, RF link budget value, and the type of application being used by the customer item, for instance streaming video, best effort data, or voice. Of course, for other devices and other services different Service Operation Parameters could be used. For example, in the case of a robotic device, the Service Operation Parameters 1060 could be shown in terms of paths traveled by the device, items stored/retrieved by the device, speed of device operation, or a current position of the device.

Recharge Command 1070 is provided to indicate whether the associated device identified in Device ID #1010 should proceed to recharge its energy source (such as a battery) during the future service period. In an aspect, for those devices that will provide service to customer items during the future service period the value in this data field is “n/a”. As seen in the last row of future service map 1000, the device LEO_SAT_4 has a value of YES in this data field indicating that it is being assigned to recharge during this future time period. Recharge Time Duration 1080 is provided to indicate the amount of time that a device that is assigned to recharge should spend recharging. In an aspect, for those devices that will provide service to customer items during the future service period the value in this data field is “n/a”. As seen in the last row of future service map 1000, the device LEO_SAT_4 has a value of YES in Recharge Command 1070 and a time value of 2 hours in Recharge Time Duration 1080 indicating that it should recharge for 2 hours maximum. Recharge To Power Level 1090 is provided to indicate the power level that a device being assigned to recharge should reach by the end of recharging. In an aspect, for those devices that will provide service to customer items during the future service period, the value in this data field is “n/a”. As seen in the last row of future service map 1000, the device LEO_SAT_4 has a value of YES in Recharge Command 1070 and has a value of 75% in Recharge To Power Level 1090 indicating that the device should recharge until it reaches 75% of its energy storage capacity. In another aspect, a device may be able to recharge while also providing service to one or more customer items at the same time during a future service period. For example, a LEO satellite may be instructed in future service map 1000 to provide service to one or more customer items during a future service period (fields 1040 to 1060) while also receiving a recharge command (field 1070) in future service map 1000 to recharge for a given recharge time duration (field 1080) or to reach a recharge power level (field 1090). In yet another aspect, a device may not currently be able to recharge and may not have a sufficient amount of remaining energy to service a customer item during a future service period. For example, a LEO satellite may not be assigned any customer items in future service map 1000 for a future service period (fields 1040 to 1060 would be “n/a” or blank for that device) and that LEO satellite would also not be assigned a recharge command (fields 1070 to 1090 would be “n/a” or blank for that device) in future service map 1000 because, for example, the LEO satellite may be in an orbit position that is out of the sunlight. As mentioned above, future service map 1000 of FIG. 10 is provided as an example and it should be appreciated that more or less data fields can be provided in the future service map, that different data fields can be used in the future service map for different types of devices and/or services, and that the future service map can be broken into individual data segments for storage and/or transmission.

According to the aspects described above, devices, systems, methods, and processes are provided to orchestrate and schedule service for customers in a system of rechargeable-energy powered devices such as, for example, satellites and IoT devices, thereby optimizing customer service quality, device power consumption, device power storage capacity, and device battery life.

Those of skill in the art will appreciate that the various method steps, illustrative logical and functional blocks, modules, units, and algorithm steps described in connection with the aspects disclosed herein can often be implemented as electronic hardware, application specific integrated chip (ASIC), computer software, or combinations of all. To clearly illustrate this interchangeability of hardware and software, various illustrative components, blocks, modules, and steps have been described above generally in terms of their functionality. Whether such functionality is implemented as hardware or software depends upon the particular constraints imposed on the overall system and devices. Skilled persons can implement the described functionality in varying ways for each particular system, but such implementation decisions should not be interpreted as causing a departure from the scope of the invention described herein. In addition, the grouping of functions within a unit, module, block, or step is for ease of description. Specific functions or steps can be moved from one unit, module, or block without departing from the invention.

Some or all of the various illustrative methods, algorithms, logical and functional blocks, units, steps and modules described in connection with the aspects disclosed herein, and those provided in the accompanying documents, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein, and those provided in the accompanying documents. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm and the processes of a block or module described in connection with the aspects disclosed herein, and those provided in the accompanying documents, can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Additionally, devices, blocks, or modules that are described as coupled may be coupled via intermediary devices, blocks, or modules. Similarly, a first device may be described as transmitting data to (or receiving from) a second device wherein there are intermediary devices that couple the first and second device and also wherein the first device is unaware of the ultimate destination of the data.

The above description of the disclosed aspects, and that provided in the accompanying documents, is provided to enable any person skilled in the art to make or use the invention. Various modifications to these aspects will be readily apparent to those skilled in the art, and the generic principles described herein, and in the accompanying documents, can be applied to other aspects without departing from the spirit or scope of the invention. Thus, it is to be understood that the description and drawings presented herein, and presented in the accompanying documents, represent particular aspects of the invention and are therefore representative examples of the subject matter that is broadly contemplated by the present invention. It is further understood that the scope of the present invention fully encompasses other aspects that are, or may become, understood to those skilled in the art based on the descriptions presented herein and that the scope of the present invention is accordingly not limited by the descriptions presented herein, or by the descriptions presented in the accompanying documents.

What we claim is:

1. A resource orchestration system for the orchestration and scheduling of rechargeable devices, the resource orchestration system comprising:
a plurality of rechargeable devices, each rechargeable device comprising a rechargeable power storage unit, a resource manager, and a service unit that provides a service to a customer item, wherein the resource manager prepares a device report for the rechargeable device that is related to a service period;
a resource orchestrator that is in communication with the plurality of rechargeable devices, that receives the device report from the resource manager of each rechargeable device, that generates a future service map that includes at least one customer item assignment of a customer item to one of the plurality of rechargeable devices for a future service period, and that sends the future service map to the resource manager of each of the plurality of rechargeable devices, wherein the resource manager of the at least one of the plurality of rechargeable devices directs the associated service unit to provide a service to an associated customer item during the future service period in accordance with the at least one customer item assignment provided in the future service map.

2. The system of claim 1 wherein the plurality of rechargeable devices comprise a plurality of communication satellites in a satellite constellation system.

3. The system of claim 2 wherein the service unit of each communication satellite is capable of providing a communication service to at least one customer item.

4. The system of claim 3 wherein the at least one customer item is a terrestrial based mobile station.

5. The system of claim 2 wherein the rechargeable power storage unit of each communication satellite is capable of being recharged by at least one solar panel provided on the communication satellite.

6. The system of claim 2 wherein the resource orchestrator is located in at least one terrestrial-based server.

7. The system of claim 2 wherein the resource orchestrator is located in at least one of the plurality of communication satellites.

8. The system of claim 1 wherein the resource orchestrator determines each customer item assignment in the future service map based on the device report received from the resource manager of each rechargeable device.

9. The system of claim 1 wherein the device report received from the resource manager of each rechargeable device includes a local service report and wherein the resource orchestrator generates a global customer report by aggregating all local service reports.

10. The system of claim 9 wherein the resource orchestrator determines each customer item assignment in the future service map based in part on the global customer report.

11. The system of claim 10 wherein the device report received from the resource manager of each rechargeable device further includes an energy report and wherein the resource orchestrator determines each customer item assignment in the future service map based in part on the global customer report and on every energy report.

12. The system of claim 1 wherein the device report received from the resource manager of each rechargeable device includes a local service report and an energy report for the associated rechargeable device.

13. The system of claim 12 wherein each energy report includes a current remaining energy level of the rechargeable device associated with the energy report.

14. The system of claim 12 wherein each energy report includes a recharge capability of the rechargeable power storage unit of the rechargeable device associated with the energy report.

15. The system of claim 1 wherein the future service map further includes at least one recharge command for at least one of the plurality of rechargeable devices to start recharging its rechargeable power storage unit during the future service period.

16. The system of claim 12 wherein each local service report includes an indication of each customer item that was served by the rechargeable device associated with the local service report during the service period.

17. The system of claim 12 wherein each local service report includes a customer subscription type for each customer item that was served by the rechargeable device associated with the local service report during the service period.

18. The system of claim 12 wherein each local service report includes a service provided indication that indicates an amount of service provided to each customer item that was served by the rechargeable device associated with the local service report during the service period.

19. The system of claim 12 wherein each local service report includes at least one service operation parameter that is related to a service configuration for the service provided to each customer item that was served by the rechargeable device associated with the local service report during the service period.

20. The system of claim 17 wherein the resource orchestrator determines the at least one customer item assignment in the future service map based at least in part on the customer subscription type for each customer item.

21. The system of claim 1 wherein the resource orchestrator determines the at least one customer item assignment in the future service map based at least in part on an energy budget associated with each of the plurality of rechargeable devices.

22. The system of claim 1 wherein the resource orchestrator determines the at least one customer item assignment in the future service map based at least in part on an energy requirement that is necessary for each rechargeable device to provide a service to an associated customer item during the future service period.

23. The system of claim 1 wherein the resource orchestrator determines the at least one customer item assignment in the future service map based at least in part on a customer list that includes identities of all customer items that are to be served by the plurality of rechargeable devices during the future service period.

24. The system of claim 12 wherein the local service report and the energy report are sent separately to the resource orchestrator by the resource manager of each rechargeable device.

25. A method for the orchestration and scheduling of rechargeable devices, the method comprising the steps of:
receiving, from a resource manager provided in each of a plurality of rechargeable devices, a device report for the associated rechargeable device related to a service period;
generating a future service map that includes at least one customer item assignment of a customer item to one of the plurality of rechargeable devices for a future service period; and
sending the future service map to the resource manager of each of the plurality of rechargeable devices.

26. The method of claim 25 wherein the plurality of rechargeable devices comprise a plurality of communication satellites in a satellite constellation system.

27. The method of claim 26 wherein each communication satellite is capable of providing a communication service to at least one customer item.

28. The method of claim 27 wherein the at least one customer item is a terrestrial based mobile station.

29. The method of claim 26 wherein a rechargeable power storage unit of each communication satellite is capable of being recharged by at least one solar panel provided on the communication satellite.

30. The method of claim 25 wherein, in the generating step, each customer item assignment is determined based on the device report received from the resource manager of each rechargeable device.

31. The method of claim 25 wherein, in the generating step, a global customer report is prepared by aggregating information from all received device reports.

32. The method of claim 25 wherein each customer item assignment is determined based at least in part on the global customer report.

33. The method of claim 25 wherein the device report received from the resource manager of each rechargeable device includes a local service report and an energy report.

34. The method of claim 33 wherein the local service report and the energy report are received separately from the resource manager of each rechargeable device.

35. The method of claim 33 wherein each energy report includes a current remaining energy level of a rechargeable power storage unit provided in the rechargeable device associated with the energy report.

36. The method of claim 33 wherein each energy report includes a recharge capability of a rechargeable power storage unit provided in the rechargeable device associated with the energy report.

37. The method of claim 25 wherein, in the generating step, at least one recharge command is included in the future service map for at least one of the plurality of rechargeable devices to start recharging during the future service period.

38. The method of claim 33 wherein each local service report includes an indication of each customer item that was served by the associated rechargeable device during the service period.

39. The method of claim 33 wherein each local service report includes a customer subscription type for each customer item that was served by the associated rechargeable device during the service period.

40. The method of claim 33 wherein each local service report includes a service provided indication that indicates an amount of service provided to each customer item that was served by the associated rechargeable device during the service period.

41. The method of claim 33 wherein each local service report includes at least one service operation parameter that is related to a service configuration for the service provided to each customer item by the associated rechargeable device during the service period.

42. The method of claim 39 wherein, in the generating step, the at least one customer item assignment is determined at least in part on the customer subscription type for each customer item.

43. The method of claim 25 wherein, in the generating step, the at least one customer item assignment is determined at least in part on an energy budget associated with each of the plurality of rechargeable devices.

44. The method of claim 25 wherein, in the generating step, the at least one customer item assignment is determined at least in part on an energy requirement that is necessary for each rechargeable device to provide a service to an associated customer item during the future service period.

45. The method of claim 25 wherein, in the generating step, the at least one customer item assignment is determined at least in part on a customer list that includes identities of all customer items that are to be served by the plurality of rechargeable devices during the future service period.
